(19) United States
(12) Patent Application Publication
(10) Pub. No.: US 2024/0265772 A1
(43) Pub. Date: Aug. 8, 2024

(54) SMART CARD AND COMMUNCATION NETWORK FOR BETTING OR GAMING SYSTEM

(71) Applicant: A Bet A Technology Limited, Alton (GB)

(72) Inventor: Christopher Erhardt Latter, Alton (GB)

(21) Appl. No.: 18/495,353

(22) Filed: Oct. 26, 2023

(30) Foreign Application Priority Data
Feb. 8, 2023 (GB) 2301759.3

(51) Int. Cl. G07F 17/32

(52) U.S. Cl. CPC G07F 17/3239; G07F 17/3251

(57) ABSTRACT

There is disclosed a betting or gaming system comprising: a token having stored thereon an identity of a portal and an identity of an account; and a user device configured to retrieve the identity of the portal from the token, access the portal, retrieve the identity of the account from the token log onto the account using the identity, and present the account on a display for use with a value associated with the account, thereby to enable a user of the user device to engage in betting or gaming activity using the portal.

### FIELD OF THE INVENTION

The invention relates to betting or gaming systems, and particularly the integration of a token such as a smart card in a betting or gaming system.

### BACKGROUND TO THE INVENTION

Betting or gaming systems provided in betting shops or casinos, online or through call centres are known.

In betting shops or casinos, betting or gaming systems may include betting or gaming terminals, in which a user enters payment (cash or debit/credit card) to the betting or gaming terminal to place a bet or stake, or a user may place a bet or stake at a counter paying a betting shop or casino operative by cash or debit/credit card.

In online betting or gaming systems, a user may logon to a website to place bets or stakes using payment via a credit/debit card.

Typically within a betting or gaming system a provider provides separate systems for a betting shop environment or casino and for an online environment.

It is an aim of the invention to provide an improved betting or gaming system.

### BRIEF DESCRIPTION OF THE FIGURES

The invention is described with reference to the following figures in which:

FIG. 1 illustrates an example betting system architecture;

FIG. 2 illustrates an example smart card;

FIGS. 3(a) to 3(d) illustrate message flows in examples; and

FIG. 4 shows an example portal.

### SUMMARY OF THE INVENTION

There is provided a betting or gaming system comprising: a token having stored thereon a unique identity of an account; and a betting or gaming terminal configured to read the token and retrieve the account information, and to access the account information to retrieve a value associated with the account, and to permit betting or gaming activity at the betting or gaming terminal in dependence on the value of the account.

The betting or gaming system may further comprise a local server connected to the betting or gaming terminal, wherein the local server communicates with a central server to retrieve the value.

There is provided a betting or gaming system comprising: a token having stored thereon an identity of a portal and an identity of an account; and a user device configured to retrieve the identity of the portal from the token, access the portal, retrieve the identity of the account from the token, log onto the account using the identity, and present the account on a display for use with a value associated with the account, thereby to enable a user of the user device to engage in betting or gaming activity using the portal. The presented account may be a logged on account, or simply account to facilitate a betting or gaming operation.

The betting or gaming system may have a local network and a central network, wherein the user device connects to the betting or gaming system via the local network. The betting or gaming system may have a local network and a central network, wherein the user device connects to the betting or gaming system via the central network. The user device may connect to the local network when in proximity of the local network.

The account identifier retrieved from the token may be provided as an input to an alias table at the central server, and may map to an account associated with a value which value is for use for betting or gaming operations. The central network may thus store an alias table, mapping unique address/account identifiers stored on tokens, to unique account identifiers associated with betting or gaming value. The unique account identifiers associated with betting or gaming value may identify accounts which are associated with the users. The unique account identifiers associated with betting or gaming value may identify accounts which are anonymous.

The betting or gaming system may further comprise a point-of-sale terminal configured to retrieve the account identity from the token and access the identified account.

The point-of-sale terminal may be configured to increase or decrease a value associated with the account in accordance with a separate value transaction at the point of sale terminal. The separate value transaction may be a purchase by cash or card, and the account value is increased. The separate value transaction may be to pay a value of the account to a user by cash or card, and the account value is decreased.

There is provided a method of operating a betting or gaming system comprising: on a token: storing an identity of an account; and at a betting or gaming terminal: reading the token; retrieving the account information; accessing the account information to retrieve a value associated with the account; and permitting betting activity at the betting or gaming terminal in dependence on the value of the account.

The betting or gaming server may communicate with a local server to retrieve the value.

There is provided a method of operating a betting or gaming system comprising: on a token: storing thereon an identity of a portal and an identity of an account; and at a user device: retrieving the identity of the portal from the token; accessing the portal; retrieving the identity of the account from the token; logging onto the account using the account identity; and presenting the account on a display for use with a value associated with the account, thereby to enable a user of the user device to engage in betting or gaming activity using the portal. The presented account may be a logged on account, or simply account to facilitate a betting or gaming operation.

The user device may connect to the betting or gaming system via a local network. The user device may connect to the betting or gaming system via a central network. The user device may connect to the local network when in proximity of the local network.

The method may further comprise retrieving the account identity from the token and accessing the identified account at a point-of-sale terminal.

The method may further comprise increasing or decreasing a value associated with the account in accordance with a separate value transaction at the point of sale terminal. The separate value transaction may be a purchase by cash or card, and the account value is increased. The separate value transaction may be to pay a value of the account to a user by cash or card, and the account value is decreased.

There is provided a token for use with a betting or gaming account, the token being configured to store an identifier identifying the betting or gaming account, and to be read by a point-of-sale terminal associated with a betting or gaming system, wherein the point-of sale system adds value to the betting or gaming account in dependence on a monetary transaction at the point-of-sale, the token being used for a betting or gaming transaction in dependence on the value associated with the account, such that the account value is decreased according to a bet value or gaming, and is increased according to a winning bet value or gaming value, and wherein the point-of-sale terminal removes value from the betting or gaming account in dependence on a value associated with the account in dependence on a monetary transaction at the point of sale to remove value from the card.

The gaming value may be a stake.

The token may be for use with a betting or gaming terminal and be configured for communicating with the betting or gaming terminal.

The token may be for use with a user device, the user device being configured to access a betting or gaming system portal.

A token may be a physical token or a virtual token. A physical token may be a smart card, or any other physical element which can electronically store information and is electronically readable and adjustable. A virtual token may be a virtual token stored on a physical device, such as a mobile phone.

### DESCRIPTION OF PREFERRED EMBODIMENTS

The invention is described below with reference to examples and embodiments in a betting system environment. The invention is not limited to a betting system environment, and may be implemented in a gaming system environment, such as a casino system environment. The following description, and the Figures, only set out examples. The scope of protection si defined by the appended claims.

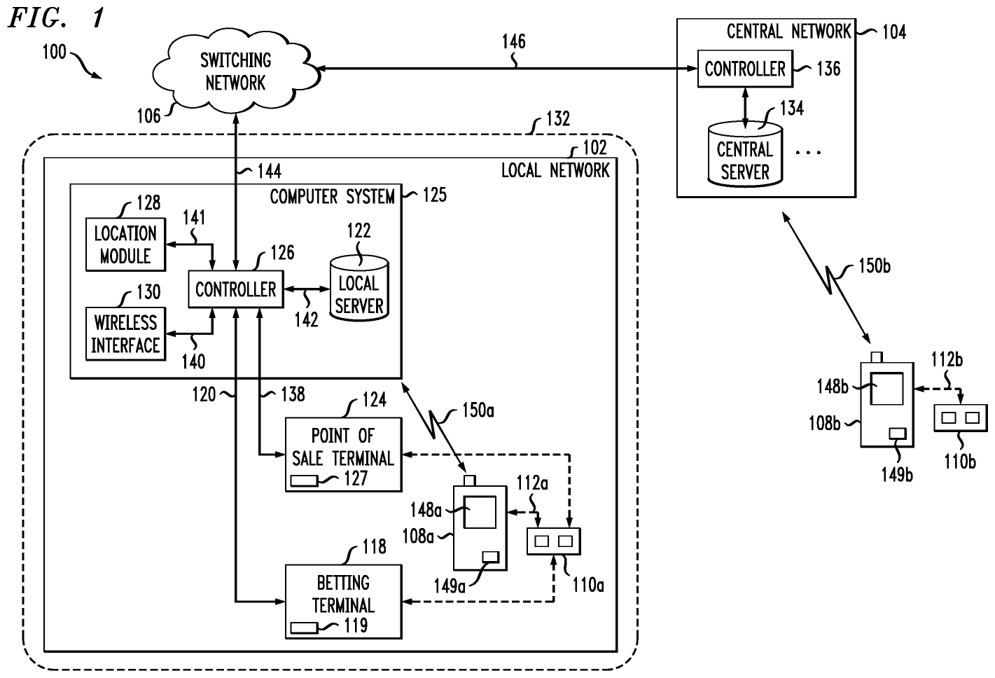

With reference to FIG. 1 there is illustrated an exemplary architecture 100 of an exemplary betting system comprising a local network 102 and a central network 104. The local network 102 and the central network 104 are connected via a switching network 106, such as a private or public network such as the Internet.

In practice there may be provided multiple local networks in communication with the central network 104.

The central network 104 comprises a central controller 136, and one or more central servers 134 connected to the controller 136. The central network 104 is connected via lines 146 to the switching network 106. The central network may 104 facilitate online operations of the betting system.

The local network 102 may be provided in a betting shop of the betting system. The local network includes a computer system 125 comprising a controller 126, one or more local servers 122 connected to the controller on line 142, a location module 128 connected to the controller on lines 141, and a wireless interface 130 connected to the controller on lines 140. The controller is connected to the switching network 106 on lines 144. The local network further includes a point-of-sale terminal 124 connected to the controller 126 on lines 138 and a betting terminal 118 connected to the controller 126 on lines 120.

The betting system is associated with multiple users, and in the example of FIG. 1 each user is associated with a user device such as a mobile phone. In FIG. 1 two user devices are shown: device 108a and device 108b. The device 108a is located in the betting shop and is connected to the local network 102. The user device 108b is located outside of a betting shop and is connected to the central network 104.

The users of the betting system are associated with smart cards. In the example of FIG. 1, the users of user devices 108a and 108b are each associated with a respective smart card 110a and 110b. Each smart card is provided to facilitate use by a user of the betting system.

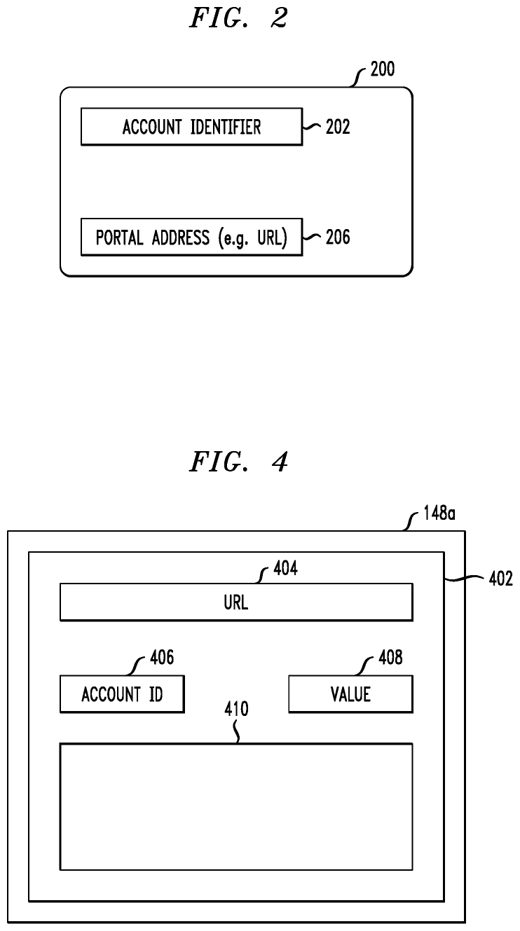

With reference to FIG. 2 there is illustrated an exemplary smart card 110. Each smart card has a unique account identifier encoded in the smart card. The smart card additionally preferably stores an IP address of a portal associated with the betting system, such as a URL of a website of the betting system. Thus as shown in FIG. 2 the smart card is configured to store a unique account identifier 202 and a portal address of the betting system 206.

The smart card 110a is preferably brought within range of a smart card reader 125 provided on the point-of-sale terminal 124, for the point-of-sale terminal 124 to read the information stored on the smart card 110a during a purchase operation. The smart card may be connected within a wireless range of the point-of-sale terminal 124, touching the point-of-sale terminal 124, fitted into a slot of the point-of-sale terminal 124 or connected to a peripheral device.

A user may purchase the smart card in the betting shop. The smart card may be purchased for a value, which value will be attributed in full to a betting account associated with the smart card. Alternatively the smart card may be purchased for a value in addition to the amount to be attributed to the account, including a purchase cost of the smart card. Additionally the smart card may be associated with an additional value provided for use with the smart card, not linked to the purchase value of the smart card, such as a free bet.

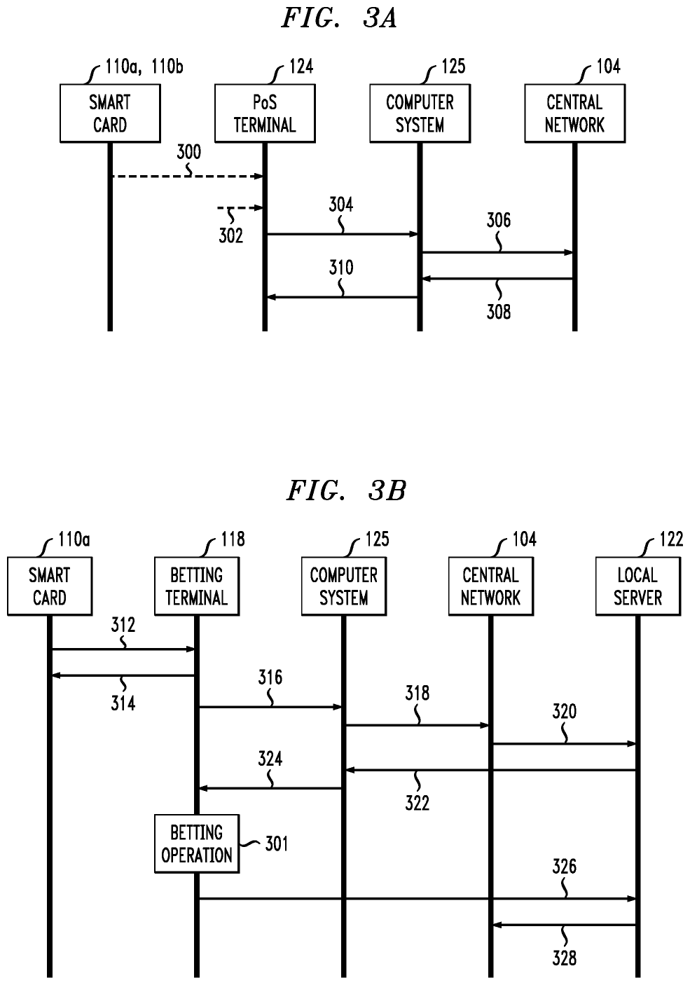

With reference to FIG. 3(a) there is illustrated an exemplary message flow associated with the purchase of the smart card, including the smart card 110a or 110b, the point-of-sale terminal 124, the local computer 125, and the central network 104. A user presents the smart card 110a, 110b to the point-of-sale terminal as denoted by dashed arrow 300, and a payment value for purchasing the smart card as denoted by dashed arrow 302 (cash or credit/debit card). The point-of-sale terminal transmits an activate message to the local computer 125 identifying the account identifier retrieved from the smart card, and the value to be credited to the account as denoted by message 304, which in turn transmits an activate message to the central network 104 identifying the account identifier and the value to be credited to the account as denoted by message 306.

The central network preferably stores an alias table, for example in the server 134. The alias table may map the account identifier provided on the smart card to a user account. For security purposes the details of the user account are not stored on the smart card itself. The unique identifier on the smart card may also map to an anonymous account, and the purchase of the smart card of any value added to the smart card does not need to be associated with an identifiable user account. The smart card and the use of the smart card can be anonymous.

The central network attributes the stated value associated with the smart card to the account identified from the alias table and stores such, returns an acknowledgement message 308 to the local computer 125, which in turn transmits an acknowledgement message 310 to the point-of-sale terminal 124. Optionally the value may be returned with the acknowledgment message, for storage in the local server 122 of the local computer 125. A local alias table may be provided in the local computer 25, or the local computer may temporarily store the value of the account associated with the account identifier on the smart card when the smart card is used.

Additional value for attribution to the betting account associated with the smart card may be purchased in the betting at the point of sale, following a similar process to FIG. 3(a). The unique identifier retrieved from the smart card is sent to the central server together with the value of any purchased credit, and the central server uses the alias table to attribute this credit to the account.

The purchase of the smart card and the application of additional value to the smart card need not be restricted to a betting shop point-of-sale terminal. This functionality may be provided in other retail outlets having an appropriate communication arrangement in place with the betting system.

A first example of the use of a smart card is now described with reference to the smart card 110a. With reference to FIG. 3(b) there is illustrated an exemplary message flow associated with the first example.

In accordance with the first example, the user uses the betting terminal 118 in the betting shop. The user brings the smart card 110a within proximity of a smart card reader 119 provided on the betting terminal 118, such that the betting terminal 118 can read the smart card 110a. A communication is established as denoted by dashed line 114. The betting terminal 118 is configured to retrieve the unique account identifier, and via the local network access the account associated with the identifier.

The smart card may connect to the betting terminal via near field communication, via contact with a pad on the betting terminal, via insertion to a slot of the betting terminal, or via a peripheral device. The requirement is that communication is established, and this may be by various means.

Referring to FIG. 3(b), messages 312 represent the provision of information from the smart card 110a to the betting terminal 118, and messages 314 represent the provision of requests from the betting terminal for information from the smart card 110a.

The betting terminal 118 transmits a message 316 to the controller 126 to obtain the value associated with the account, which includes the account identifier. The controller forwards this information with a request message 318 to the central network 104. The central network accesses the account value with use of the alias table, and returns it to the local server 122 in message 320. The local server 122 provides this value to the controller 126 of the computer 125 in message 322, which in turn provides the value to the betting terminal in message 324.

The betting terminal then operates to facilitate the users betting in dependence on the value associated with the account as denoted by step 301. The monetary value of the account is then made available to the user, to use on the betting terminal, to place bets.

Use of the smart card is terminated when the communication link on line 114 is broken, i.e., when the smart card 110a is moved away from the betting terminal 118. In arrangements the betting terminal may display an option on a user interface for a user to terminate a session with the smart card, and the connection 114 need not be maintained during operation. The session may be timed out after a certain duration of inactivity.

On completion of the session, the betting terminal 118 forwards a message 326 to the local server 122 of the computer 125 identifying the remaining account balance, and in turn the local server 122 forwards this to the central network 104. The central network uses the identifier in the message to access the alias table, and update the account value associated with the account.

A second example of the use of a smart card is described with reference to the user device 108a, located in the betting shop, and the smart card 110a. With reference to FIG. 3(c) there is illustrated an exemplary message flow associated with the second example.

In accordance with the second example, the user uses their mobile phone 110a in the betting shop. The user brings the smart card 110a within proximity of the user device 110a, such that a near field reader 149a provided in the user device 110a can read the smart card 110a. A communication is established as denoted by dashed line 112a. The user device 110a is configured to retrieve the URL (or more generally an IP address) stored on the smart card, and via the local network access a portal page associated with the URL, such as a web page. The user device also retrieves the unique account identifier, and via the local network accesses the account associated with the identifier, using the password credentials also retrieved from the smart card. A portal for the betting system is then displayed on a display 148a of the user device 110a. The monetary value of the account is then made available to the user, to use on the betting system portal, to place bets.

The smart card 110a may connect to the user device 108 a via near field communication, via contact with a pad on the user device, via insertion to a slot of the user device, or via a peripheral device. The requirement is that communication is established, and this may be by various means.

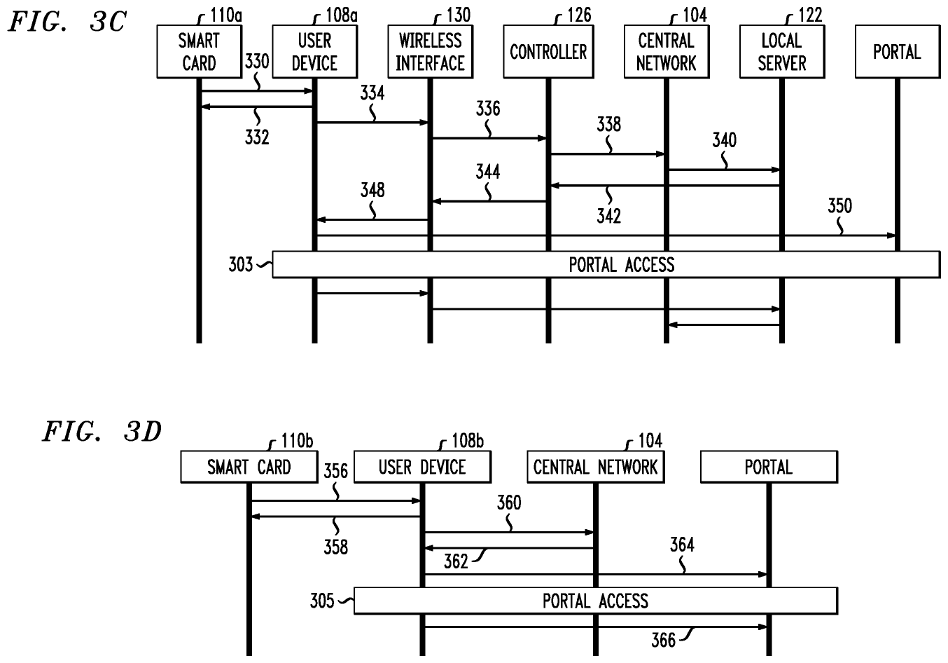

With reference to FIG. 4 there is shown an example of a portal 402. Reference numeral 404 denotes the URL of the portal. Reference numeral 406 denotes the account identifier which may be displayed, and reference numeral 408 denotes the account value which is preferably displayed. Reference numeral 410 denotes the general window in which betting options are provided.

The user device 108a establishes a wireless connection with the local network, as denoted by connection 150a, to the wireless interface 130 of the computer system 125.

Referring to FIG. 3(c), messages 330 represent the provision of information from the smart card 110a to the user device 108a, and messages 332 represent the provision of requests from the user device 108a for information from the smart card 110a.

The user device 108a transmits a message 334 to the wireless interface 130, which in turn transmits a message 336 to the controller 126 to request the value associated with the account, which includes the account identifier. The controller 126 forwards this information with a request message 338 to the central network 104. The central network 104 uses the account identifier and the alias table to access the account value and returns it to the local server 122 in message 340. The local server 122 provides this value to the controller 126 in message 342, which in turn provides the value to the wireless interface 130 in message 344, and which in turn provides the value in message 348 to the user device 108a.

The user device 108a then accesses the portal (or web address) associated with the retrieved information from the smart card as denoted by message 350.

The user device 108a then operates to facilitate the users betting in dependence on the value associated with the account. The monetary value of the account is then made available to the user, to use on the betting terminal, to place bets. This is denoted by operation step 303.

Use of the smart card is terminated when the communication link on line 112a is broken, i.e., when the smart card 110a is moved away from the user device 108a. In arrangements the user device 108a may display an option on the display 148a for a user to terminate a session with the smart card, and the link on line 112 does not have to be maintained during use. A session may be timed out after inactivity.

On completion of the session, the user device 108a forwards a message 352 to the wireless interface 130, which in turn forwards a message 354 to the local server 122, which in turn forwards a message to the central server 354. The remaining account balance is thus stored by the central server.

A third example is described with reference to user device 108b, located outside a betting shop, and the smart card 110b.

In accordance with the third example, the user uses their mobile phone 110b. The user brings the smart card 110b within proximity of the user device 110b, such that a near field reader 149b provided in the user device 110b can read the smart card 110a. A communication is established as denoted by dashed line 112b. The user device 110b is configured to retrieve the URL stored on the smart card, and via the centralised network access a portal page associated with the URL, such as a web page. The user device 110b also retrieves the unique account identifier and via the alias table of the central network accesses the account associated with the identifier. A portal for the betting system is then displayed on a display 148b of the user device 110b. The monetary value of the account is then made available to the user, to use on the betting system portal, to place bets.

The smart card 110b may connect to the user device 108b via near field communication, via contact with a pad on the user device, via insertion to a slot of the user device or via a peripheral device. The requirement is that communication is established, and this may be by various means.

The user device 108b establishes a wireless connection with the central network, as denoted by connection 150b.

Referring to FIG. 3(d), messages 356 represent the provision of information from the smart card 110b to the user device 108b, and messages 358 represent the provision of requests from the user device 108b for information from the smart card 110b.

The user device 108b transmits a message 360 to the central server 134 to obtain the value associated with the account, which includes the account identifier. The central server 134 accesses the account value using the alias table, and returns it to the user device 108b in message 362.

The user device 108a then accesses the portal (or web address) associated with the retrieved information from the smart card as denoted by message 350.

The user device 108a then operates to facilitate the users betting in dependence on the value associated with the account. The monetary value of the account is then made available to the user, to use on the user device 108b, to place bets. This is denoted by operation 305.

Use of the smart card is terminated when the communication link on line 112b is broken, i.e. when the smart card 110b is moved away from the user device 108b. In arrangements the user device 108b may display an option on the display 148b for a user to terminate a session with the smart card, and the link on line 112b does not have to be maintained during use. The session may be timed out due to inactivity.

On completion of the session, the user device 108b forwards a message 366 to the central server 134. The remaining account balance is thus stored by the central server, again with use of the alias table.

Any stored data may be encrypted. Data stored on a smart card, such as the unique address identifier or the IP address, may be encrypted. Data stored anywhere in the betting system, such as in the local network or on the central network, may be encrypted.

When the user device 110a or 110b is located within a betting shop, and thus can be connected wirelessly to the local network, this is preferable than connecting the device to the central network. The location module 128 is configured to determine the location of the user device in order to force connection through the local network when connectable to the local network. A geofence 132 may be provided to assist in this operation.

In the examples above the smart cards 110a, 110b are physical smart cards, and may be any physical token. In alternatives, there may be provided virtual smart cards in a wallet of the user device, which may be considered virtual tokens. The processes described above operate identically for a virtual smart card or token as for a physical smart card or token, and may be generally defined as operating with a token.

In the first example described above with reference to FIG. 3(a), a user device is not required, and the example provides an operation with a physical smart card.

In the second example described above the user device is connected in the local network, and communicates with a smart card. The smart card may be a physical or virtual smart card. The local network is in communication with a central network. The local network and the central network are networks of the same betting system, and are private networks of the betting system which connect to public mobile networks or other public connector networks. The local network is provided in a betting shop.

In the third example described above the user device is connected in a central network, and communicates with a smart card. The smart card may be a physical or virtual smart card. The user device may be located at a betting track, or any location where connection of the user device to the central network is possible. The central network is a private network of a betting system.

Any monetary value associated with placing a bet is automatically deducted from the account associated with the unique account identifier on the smart card.

Any monetary value associated with winning a bet is automatically credited to the account associated with the unique account identifier on the smart card.

The smart card may be presented at the point-of-sale terminals 124 for the user to exchange the value associated with the account the smart card is linked to for an appropriate payment—e.g., either a payment to a bank card of the user, or a cash payment.

Whilst preferred embodiments of the invention have been described above with reference to a betting system environment, as set out above the invention may be applied in a gaming system environment, such as a casino.

A betting system environment and a gaming system environment may be considered synonymous, with a bet being placed in a betting system environment and a stake being placed (or made) in a casino system environment—the bet and the stake both having an attributed value.

Any process described herein may be implemented as computer software on a computer system, including the transmission messages. A computer program product may be provided with computer software which, when executed by a computer, may perform any process described.

The invention has been described by way of examples and embodiments. The invention is not limited to the particulars of any example of embodiment given.

1. A betting or gaming system comprising:
a token having stored thereon a unique identity of an account; and
a betting or gaming terminal configured to read the token and retrieve the account information, and to access the account information to retrieve a value associated with the account, and to permit betting activity at the betting or gaming terminal in dependence on the value of the account.

2. The betting or gaming system of claim 1 further comprising a local server connected to the betting or gaming terminal, wherein the local server communicates with a central server to retrieve the value.

3. A betting or gaming system comprising:
a token having stored thereon an identity of a portal and an identity of an account; and
a user device configured to retrieve the identity of the portal from the token, access the portal, retrieve the identity of the account from the token log onto the account using the identity, and present the account on a display for use with a value associated with the account, thereby to enable a user of the user device to engage in betting or gaming activity using the portal.

4. The betting or gaming system of claim 3 having a local network and a central network, wherein the user device connects to the betting or gaming system via one of a local network and a central network, wherein the user device connects to the local network when in proximity of the local network.

5. The betting or gaming system of claim 3 further comprising a point-of-sale terminal configured to retrieve the account identity from the token and access the identified account.

6. The betting or gaming system of claim 5 wherein the point-of-sale terminal is configured to increase or decrease a value associated with the account in accordance with a separate value transaction at the point-of-sale terminal.

7. The betting or gaming system of claim 6 wherein the separate value transaction is a purchase by cash or card, and the account value is increased.

8. The betting or gaming system of claim 6 wherein the separate value transaction is to pay a value of the account to a user by cash or card, and the account value is decreased.

9. A method of operating a betting or gaming system comprising:
on a token:
storing an identity of an account; and
at a betting or gaming terminal:
reading the token;
retrieving the account information;
accessing the account information to retrieve a value associated with the account; and
permitting betting activity at the betting or gaming terminal in dependence on the value of the account.

10. The method of operating a betting system of claim 9 wherein the betting or gaming server communicates with a local server to retrieve the value.

11. A method of operating a betting or gaming system comprising:
on a token:
storing thereon an identity of a portal and an identity of an account; and
at a user device:
retrieving the identity of the portal from the token;
accessing the portal;
retrieving the identity of the account from the token;
logging onto the account using the account identity; and
presenting the account on a display for use with a value associated with the account, thereby to enable a user of the user device to engage in betting or gaming activity using the portal.

12. The method of operating a betting or gaming system of claim 11 wherein the user device connects to the betting or gaming system via a local network or a central network.

13. The method of operating a betting or gaming system of claim 12 wherein the user device connects to the local network when in proximity of the local network.

14. The method of operating a betting or gaming system of claim 9 further comprising retrieving the account identity from the token and accessing the identified account at a point-of-sale terminal.

15. The method of operating a betting or gaming system of claim 14 further comprising increasing or decreasing a value associated with the account in accordance with a separate value transaction at the point-of-sale terminal.

16. The method of operating a betting or gaming system of claim 15 wherein the separate value transaction is a purchase by cash or card, and the account value is increased.

17. The method of operating a betting or gaming system of claim 15 wherein the separate value transaction is to pay a value of the account to a user by cash or card, and the account value is decreased.

18. A token for use with a betting or gaming account, the token being configured to store an identifier identifying the betting or gaming account, and to be read by a point-of-sale terminal associated with a betting or gaming system, wherein the point-of sale system adds value to the betting or gaming account in dependence on a monetary transaction at the point-of-sale, the token being used for a betting or gaming transaction in dependence on the value associated with the account, such that the account value is decreased according to a bet value or gaming value, and is increased according to a winning bet value or gaming value, and wherein the point-of-sale terminal removes value from the betting or gaming account in dependence on a value associated with the account in dependence on a monetary transaction at the point of sale to remove value from the card.

19. The token of claim 18 for use with a betting or gaming terminal and being configured for communicating with the betting or gaming terminal.

20. The token of claim 18 for use with a user device, the user device being configured to access a betting or gaming system portal.
